(19) United States
(12) Patent Application Publication
(10) Pub. No.: US 2024/0198416 A1
(43) Pub. Date: Jun. 20, 2024

(54) SHAFT AND POST ASSEMBLIES FOR MOLTEN APPARATUS

(71) Applicant: PYROTEK, INC., Spokane, WA (US)

(72) Inventors: Andrew HORSFALL, Cuyahoga Falls, OH (US); Sean CULLEN, Kent, OH (US); John TIPTON, Aurora, OH (US)

(21) Appl. No.: 18/287,946

(22) PCT Filed: Apr. 25, 2022
(86) PCT No.: PCT/US2022/026169

§ 371 Date: Oct. 23, 2023

Related U.S. Application Data
(60) Provisional application No. 63/179,029, filed on Apr. 23, 2021.

(51) Int. Cl. B22D 39/00; F04D 7/06; F27D 27/00

(52) U.S. Cl. CPC B22D 39/00; F04D 7/065; F27D 27/005

(57) ABSTRACT

A molten metal pump post that includes an elongated rod of a first material that is heat resistant and an inner member at least partially surrounding the elongated rod. The inner member is of a second material. The elongated rod is operable due to a difference in a coefficient of thermal expansion between the elongated rod and the inner member which creates a compressive force.

This application claims the benefit of U.S. Provisional Application No. 63/179,029 filed Apr. 23, 2021, the disclosure of which is herein incorporated by reference.

### BACKGROUND

The present exemplary embodiment relates to a molten metal pumping system. Pumps for pumping molten metal are used in furnaces for the production of metal articles. Common functions of pumps are circulation of molten metal in the furnace or transfer of molten metal to remote locations. The present description is focused on molten metal pumps for transferring metal from one location to another. It finds particular relevance to systems where molten metal is elevated from a furnace bath into a launder system.

Currently, many metal die casting facilities employ a main hearth containing the majority of the molten metal. Solid bars of metal may be periodically melted in the main hearth. A transfer pump can be located in a well adjacent the main hearth. The transfer pump draws molten metal from the well and transfers it into a conduit, and from there, to a die casting machine that forms metal articles. The present disclosure relates to pumps used to transfer molten metal from a furnace to a die casting machine, ingot mold, or the like. The present disclosure can employ, for example, the style of pumping systems described in U.S. Pat. Nos. 10,415,884; 10,072,891; 9,909,808; 9,982,945; and 10,352,620, the disclosures of which are herein incorporated by reference.

Typically, a launder is used to transfer the molten from the pumping system to a casting location. The launder is essentially a trough, channel or conduit outside of the reverbatory furnace. A launder may be used to pass molten metal from the furnace and into a ladle and/or into molds. The launder may be of any dimension or shape. For example, it may be one to four feet in length, or as long as 100 feet in length. The launder is usually sloped gently, for example, it may be sloped downward or gently upward at a slope. In use, a typical launder includes molten aluminum at a depth of approximately 1-10″.

When feeding a ladle, launder or other structure or device utilizing a transfer pump, the pump is turned off/on and accelerated according to when more molten metal is needed. This can be done automatically. If done automatically, the pump may turn on and/or accelerate when the molten metal in the ladle or launder is below a certain amount.

The present invention relates to an apparatus for degassing, submerging, agitating and pumping molten metal. Particularly, the present invention relates to a mechanical apparatus for moving or pumping molten metal such as aluminum, zinc or magnesium. More particularly, the present invention is related to a drive for such an apparatus in which a motor is positioned above a molten metal bath and rotates a vertical shaft. The lower end of the shaft drives an impeller or a rotor to impart motion to the molten metal. The middle portion of the assembly is supported by a steel shaft, which is reinforced by a ceramic post. The invention finds similar application in the construction of the post which supports the motor.

In the processing of molten metals, it is often necessary to pump molten metal from one place to another. When it is desired to remove metal from a vessel, a so-called transfer pump is used. When it is desired to circulate molten metal within a vessel, a so-called circulation pump is used. When it is desired to purify molten metal disposed within a vessel, a so-called gas injection pump is used. In each of these pumps, a rotatable impeller is submerged, typically within a pumping chamber, in the molten metal bath contained in the vessel. Additionally, the motor is suspended on a superstructure over the bath by posts connected to the base. In another embodiment of these pumps, a rotatable impeller can be submerged in the molten metal bath by a shaft affixed to a suspended motor, where the motor is not supported over the bath by any posts. Rotation of the impeller within the pumping chamber forces the molten metal as desired in a direction permitted by the pumping chamber design.

Mechanical pumps for moving molten metal in a bath historically have a relatively short life because of the destructive effects of the molten metal environment on the material used to construct the pump. Moreover, most materials capable of long term operation in a molten metal bath have relatively poor strength which can result in mechanical failure. In this regard, the industry has typically relied on graphite, a material with adequate strength, temperature resistance and chemical resistance, to function for an acceptable period of time in the harsh molten metal environment.

While graphite is currently the most commonly used material, it presents certain difficulties to pump manufacturers. Particularly, mechanical pumps usually require a graphite pump housing submerged in the molten metal. However, the housing is somewhat buoyant in the metal bath because the graphite has a lower density than the metal. In order to prevent the pump housing from rising in the metal and to prevent unwanted lateral movement of the base, a series of vertical legs are positioned between the pump housing and an overhead structure which acts simultaneously to support the drive motor and locate the base. In addition to functioning as the intermediate member in the above roles, the legs, or posts as they are also called, must be strong enough to withstand the tensile stress created during installation and removal of the pump in the molten metal bath.

Similarly, the shaft connecting the impeller and the motor is constructed of graphite. Often, this shaft component experiences significant stress when occluding matter in the metal bath is encountered and sometimes trapped against the housing. Since graphite does not possess as high a strength as would be desired, it would be helpful to reinforce the leg and shaft components of the pump.

A shaft or post assembly made entirely of ceramic would be brittle and subject to an unexpected failure. Furthermore, exposed metal components residing in the molten metal bath can dissolve.

In addition, graphite can be difficult to work with because graphite has different thermal expansion rates in its two grain orientations. This may result in a post and base having divergent and conflicting thermal expansion rates in the molten metal environment. This problem is compounded by the fact that pump construction has historically required cementing the graphite post into a hole in the graphite base. This design provides no tolerance between the components to accommodate this divergent thermal expansion. Unfortunately, this can lead to cracking of the base or the post. Accordingly, it would be desirable to have a molten metal pump wherein the mating of a post and a base is achieved in a manner which accommodates divergent thermal expansion tendencies.

The present invention is equally applicable to a variety of other apparatus used in processing molten metal. Moreover, in addition to pumps, molten metal scrap melting (i.e. submergence), degassing, and agitation equipment, typically rely on the rotation of an impeller/rotor submerged by a vertical shaft in a bath of molten metal. More specifically, a submergence device is used to help melt recycle materials. Two major concerns of the secondary metal industry are production rate and recovery or yield. Recovery is lowered by the generation of oxides and gasses which become entrained or dissolved into the molten metal during the melting of scrap metal. In addition to a loss in yield, entrained impurities decrease the quality and value of the scrap metal which is ultimately marketable as end product. Accordingly, a degassing device is often used to remove these impurities. In the degasser, a hollow shaft is typically provided to facilitate the injection of gas down the shaft and out through the bores in an impeller/shaft rotor. Typically, the introduced gasses will chemically release the unwanted materials to form a precipitate or dross that can be separated from the remainder of the molten metal bath.

An example of a submergence device is described in U.S. Pat. Nos. 4,598,899 and 6,071,024 herein incorporated by reference. An exemplary degassing apparatus is described in U.S. Pat. No. 4,898,367, herein incorporated by reference. In both devices, a vertically oriented shaft having an impeller/rotor disposed at one end in the molten metal bath is employed. Similar problems arise in these apparatuses wherein the components are usually constructed of graphite, and would benefit from an increase in strength.

### BRIEF DESCRIPTION

Various details of the present disclosure are hereinafter summarized to provide a basic understanding. This summary is not an extensive overview of the disclosure and is neither intended to identify certain elements of the disclosure, nor to delineate scope thereof. Rather, the primary purpose of this summary is to present some concepts of the disclosure in a simplified form prior to the more detailed description that is presented hereinafter.

According to a first embodiment, a molten metal pump post is provided. The molten metal pump post includes an elongated rod of a first material that is heat resistant and an inner member at least partially surrounding the elongated rod. The inner member is of a second material. The elongated rod is operable due to a difference in a coefficient of thermal expansion between the elongated rod and the inner member which creates a compressive force.

According to a second embodiment, an assembly for attaching an associated molten metal pump post to a component of a molten metal pump is provided. The assembly includes a rod having a first end that accommodates an elongated refractory element and an opposed end at least partially surrounded by an inner member wherein the assembly uses thermal expansion to create a compressive force.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a front elevation view, partially in cross-section, of a molten metal pump in accordance with one aspect of the present disclosure;

FIG. 2 is a side elevation view, also partially in cross-section, of FIG. 1;

FIG. 3 is a front elevation view, partially in cross-section, of the rod of FIG. 1;

FIG. 4 is a front elevation view, in cross-section, of the outer sheath of FIG. 1;

FIG. 5 is a front elevation view, in cross-section, of an alternative post embodiment;

FIG. 6A is a side view, in cross-section, of an alternative post configuration;

FIG. 6B is a post configuration similar conceptually to the embodiment of FIG. 6A with added engineering detail;

FIG. 7A is a cross-sectional side view of a further post configuration;

FIG. 7B is a cross-sectional perspective view of the post of FIG. 7A;

FIG. 8A is a cross-sectional side view of another embodiment of a post configuration; and

FIG. 8B is a cross-sectional perspective view of the post of FIG. 8A.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used herein, the terms about, generally and substantially are intended to encompass structural or numerical modifications which do not significantly affect the purpose of the element or number modified by such term.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

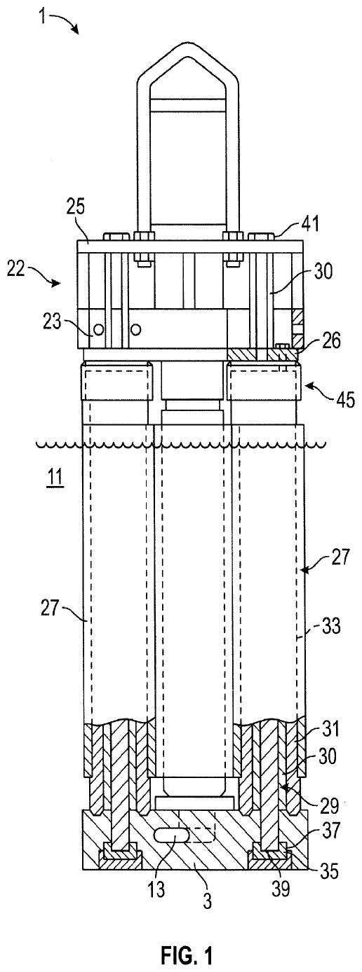

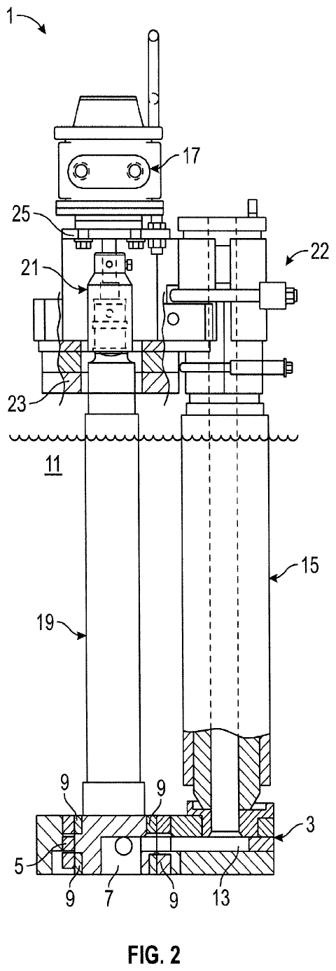

Referring now to FIG. 1 and FIG. 2, a molten metal transfer pump 1 is provided. The molten metal pump 1 includes a base assembly 3 having a pumping chamber 5 with an impeller 7 disposed therein. Bearing rings 9 provide mating surfaces between the impeller 7 and the base assembly 3. Rotation of the impeller 7 forces molten metal 11 through outlet 13 and up riser tube 15 for transport to another location.

Rotation of impeller 7 is achieved when motor 17 rotates shaft 19 by turning shaft coupling 21 provided therebetween. The motor 17 is positioned above the base assembly 3 on a platform assembly 22 having an insulation layer 23, a motor mount bracket 25 and a motor mount plate 26.

In an embodiment as depicted in FIG. 1, two post assemblies 27 are shown. However, any number of post assemblies could be used in the present invention, preferably one, two or four. In one embodiment, two post assemblies 27, comprised of a rod 29 constructed of a heat resistant alloy material disposed within an inner member 30 and an outer sheath 31 suspend the base assembly 3 below the platform 22. The inner member 30 is disposed between the rod 29 and the outer sheath 31. The inner member can be a material to wet out molten metal that may penetrate the outer sheath. The inner member can comprise Tungsten, Titanium or other similar material.

In one embodiment, the rod will be constructed of an alloy such as MSA 2000 or MSA 2001 available from Pyrotek, Inc. of Spokane, WA. The optional outer sheath 31 includes a ceramic shield for additional protection against oxidation, erosion, corrosion, etc. The lower end of rod 29 includes cap 35. Cap 35 is disposed within a cavity 37 in base assembly 3. A graphite or refractory plug 39 is cemented into the lowermost portion of the cavity 37 to seal the area from molten metal. Plug 39 is such that its diameter is sufficiently large to include the rod 29 and cap 35, while still sealing the connection within the housing. The upper end of the rod 29 extends through the insulation layer 23 and is secured with nut 41 to motor mount plate 26. The inner member 30 is disposed between the motor mount platform 25 and insulation layer 23.

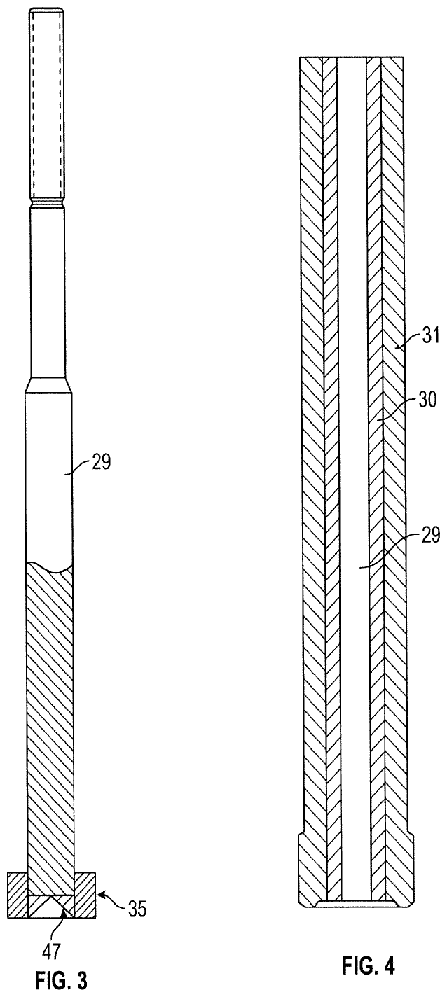

Turning now to FIG. 3, a detailed depiction of rod 29 is provided. In this embodiment, cap member 35 is welded at weld lines 47 to the lower most end of the rod. Of course, other mechanisms of attachment, including but not limited to, threaded or swaged, are appropriate joining techniques. FIG. 4 provides a detailed cross-sectional view of rod 29 surrounded by inner member 30 and outer sheath 31.

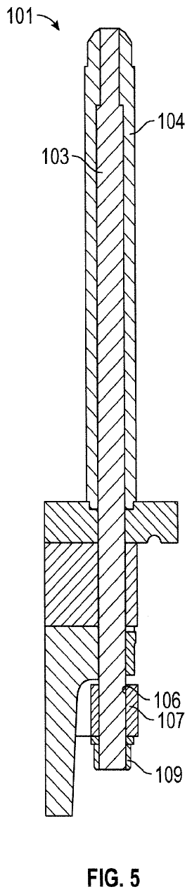

Turning now to FIG. 5, an alternative post embodiment is shown. In this embodiment, the post 101 again includes a rod 103 protected from the molten metal environment by an inner member 104. Rod 103 passed through a bore/cavity 106 in a base member 107 and is retained by the cap 109. A compressive force is generated wherein the elongated rod 103 is operable due to a difference in a coefficient of thermal expansion between the elongated rod 103 and the inner member 104.

Table 1 below discloses examples of the length/thickness (inches) and expansion coefficients/K for an embodiment of FIG. 5, including the outside materials growth (inner member), inside materials growth (rod), and the difference, i.e. the coefficient of thermal expansion (CTE). The CTE is shown at various temperature changes, ranging from 25° C. to 200° C. In other words, the materials used in preparing the rod 103 and the inner member 104 generate compression by using the differences in coefficient of thermal expansion (CTE) of the different materials. Of course, other materials with corresponding CTE differences could also be used. This improvement offers the advantage over the known use of springs, which can be subject to mechanical failure over time.

TABLE 1

| Length | Expansion | ΔT | | | | | | | |
|---|---|---|---|---|---|---|---|---|---|
| Thickness | Coefficient | (C.) | | | | | | | |
| (IN) | (K) | 25 | 50 | 75 | 100 | 125 | 150 | 175 | 200 |

Outside Materials Growth

| | | | | | | | | | | |
|---|---|---|---|---|---|---|---|---|---|---|
| A36 Steel | 7.158 | 0.0000117 | 0.002094 | 0.004187 | 0.006281 | 0.008375 | 0.010469 | 0.012562 | 0.014656 | 0.01675 |
| 304 Stainless Steel | 0.75 | 0.0000178 | 0.000334 | 0.000668 | 0.001001 | 0.001335 | 0.001669 | 0.002003 | 0.002336 | 0.00267 |
| N-14 | 1.5 | 0.000007 | 0.000263 | 0.000525 | 0.000788 | 0.00105 | 0.001313 | 0.001575 | 0.001838 | 0.0021 |
| FS59AL | 1 | 0 | 0 | 0 | 0 | 0 | 0 | 0 | 0 | 0 |
| 304 Stainless Steel | 1 | 0.0000178 | 0.000445 | 0.00089 | 0.001335 | 0.00178 | 0.002225 | 0.00267 | 0.003115 | 0.00356 |

| | | | | | | | | |
|---|---|---|---|---|---|---|---|---|
| Total Growth | 0.003135 | 0.00627 | 0.009405 | 0.01254 | 0.015675 | 0.01881 | 0.021945 | 0.02508 |

Inside Materials Growth

| | | | | | | | | | | |
|---|---|---|---|---|---|---|---|---|---|---|
| Tungsten | 11.408 | 0.0000045 | 0.001283 | 0.002567 | 0.00385 | 0.005134 | 0.006417 | 0.0077 | 0.008984 | 0.010267 |
| Titanium | 11.408 | 0.0000088 | 0.00251 | 0.00502 | 0.007529 | 0.010039 | 0.012549 | 0.015059 | 0.017568 | 0.020078 |

Difference (Outer − Inner)

| | | | | | | | | |
|---|---|---|---|---|---|---|---|---|
| Tungsten | 0.001852 | 0.003703 | 0.005555 | 0.007406 | 0.009258 | 0.011109 | 0.012961 | 0.014813 |
| Titanium | 0.000625 | 0.00125 | 0.001876 | 0.002501 | 0.003126 | 0.003751 | 0.004376 | 0.005002 |

It is also contemplated by the present disclosure that CTE can be used to provide compression in a preassembled post configuration. Moreover, CTE can be used without reliance on the motor mount or pump base. For example, the CTE assembly can replace the spring element utilized in U.S. Pat. No. 10,641,270, the disclosure of which is herein incorporated by reference.

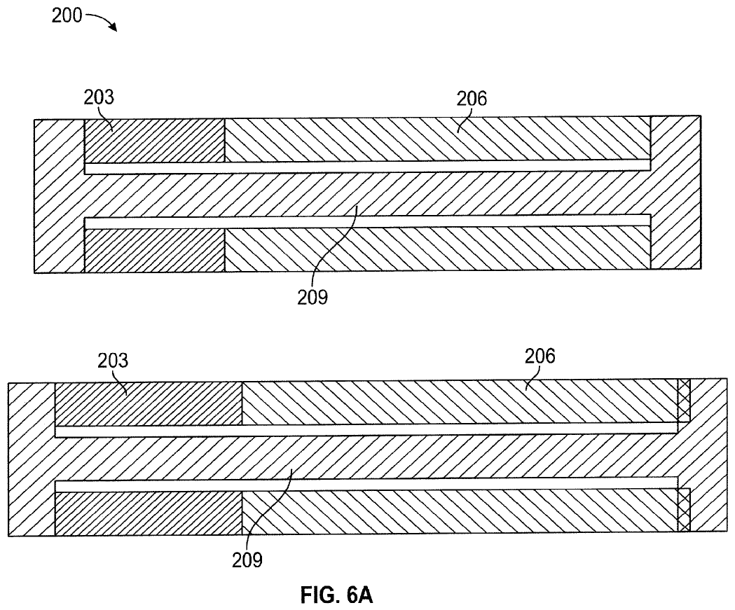

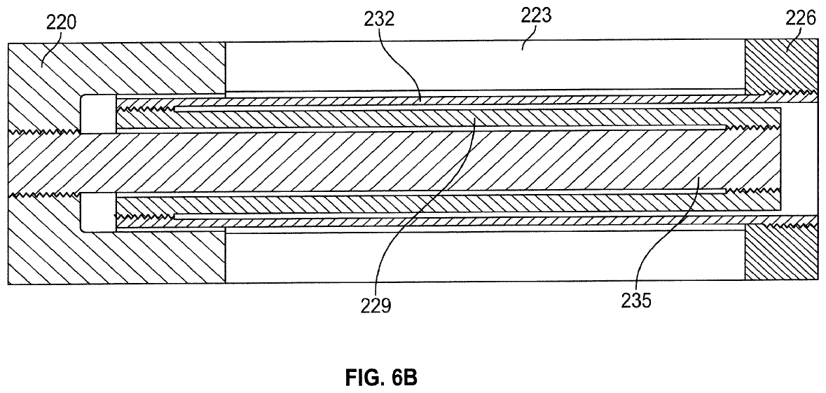

Turning now to FIGS. 6A and 6B, the spring element utilized in U.S. Pat. No. 10,641,270 can be replaced with an alternate material composition 200 that relies on CTE to provide compression in a preassembled post configuration. In this embodiment, the alternate material composition 200 is designed to ensure that at ambient temperature, material A 203 and material B 206 are in compression, while material C 209 is in tension. This can be expressed with the equation L_{A}+L_{B}=L_{C}. Materials A, B, and C are chosen so that their expansion properties ensure that at elevated temperatures, material A and material B remain in tension while material C remains in tension. This can be expressed with the following equations:

L_{A}+E_{A}+L_{B}+E_{B}>L_{C}+E_{C}

(L_{A}+L_{B})+E_{A}+E_{B}>L_{C}+E_{C}

L_{C}+E_{A}+E_{B}>L_{C}+E_{C}

E_{A}+E_{B}>E_{C}

This alternate material composition ensures that the goal of maintaining material B in compression is achieved.

As shown in FIG. 6B, the top block 220 is chosen for its high CTE. It does not need to survive full furnace temperatures. The middle block 223 material is chosen for its endurance to molten aluminum, a ceramic material is an example material. The middle block 223 benefits from compression applied axially. The bottom block 226 comprises material chosen for its high CTE. The bottom block 226 material must survive full furnace temperatures. The expansion tube 229 comprises a material chosen for its high CTE, it must survive full furnace temperatures. The tension tube 232 comprises a material chosen for its low CTE, it must survive full furnace temperatures. The tension rod 235 comprises a material chosen for its low CTE, it must survive full furnace temperatures. Accordingly, the use of these materials as shown in FIG. 6B with the appropriate CTE allow the CTE to be used to provide compression in a preassembled post configuration, thus allowing CTE to be used without reliance on a motor mount, a pump base, or springs, as done so in the prior art.

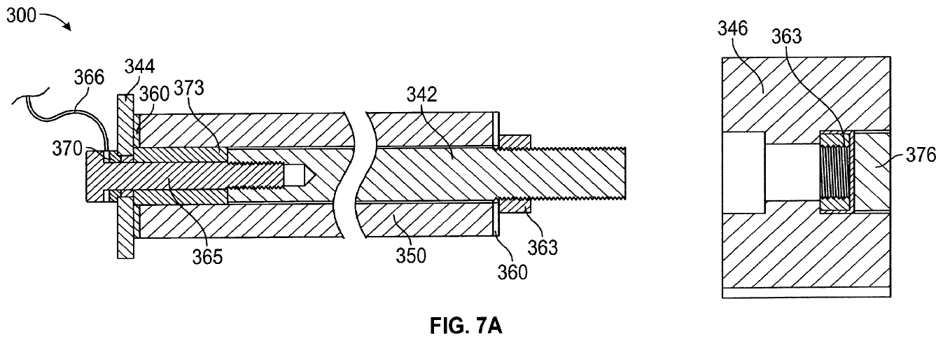

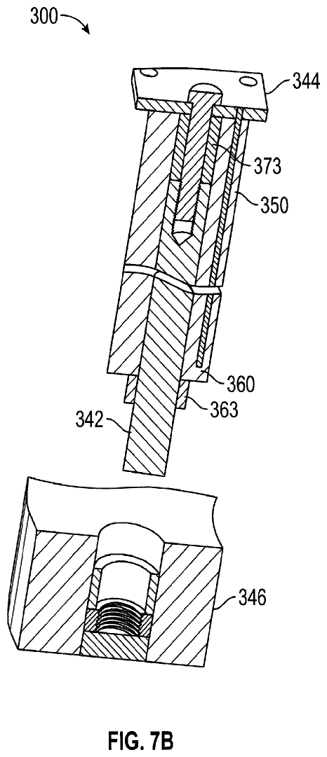

In various embodiments and with reference to FIGS. 7A and 7B, a post 300 comprises a tube 350, an elongated rod 342, a base assembly 346, and a flange 344. The elongated rod 342 may at least be partially surrounded by an inner wall 350. In one embodiment, the rod 342 comprises a carbon-carbon rod and the support post 300 comprises a ceramic material due to its endurance to molten aluminum. In this embodiment, the inner wall 350 comprises silicon carbide ceramic. In this embodiment, the base assembly 346 comprises graphite and is configured to receive, engage, retain, and/or otherwise mate to the first end of the tube 350. The elongated rod 342, by comprising a carbon-carbon material, can be pre-loaded with pressure that will not unload at an increased temperature. In other words, the use of CTE negates the need for the prior art use of a spring, which is subject to mechanical failure over time. Also shown is a grafoil gasket 360, a stainless steel nut 363, a stainless steel bolt 365, an electrical leak detector 366, a ceramic electrical isolator 370, and ceramic wool packing 373, as are routinely used in the field in conventional manners known to those of skill in the art. The base assembly 346 may comprise graphite a graphite cap 376, and could include a stainless steel nut 363 to secure the elongated rod 342.

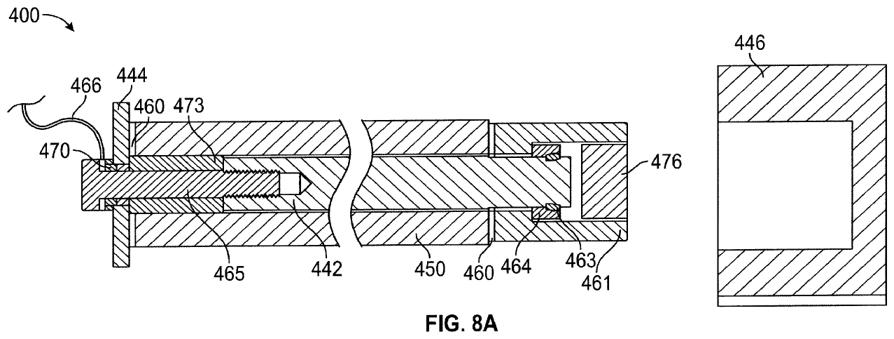

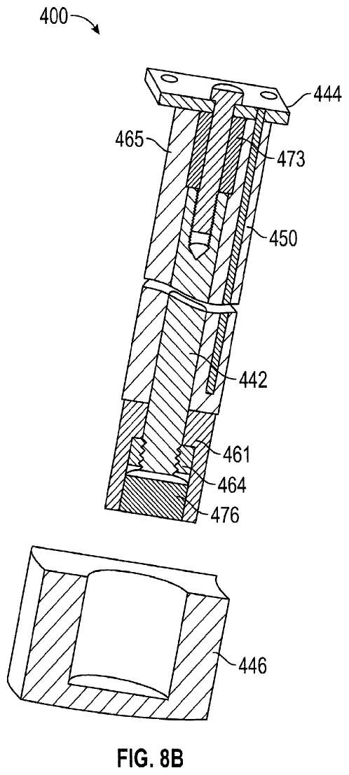

In various embodiments and with reference to FIGS. 8A and 8B, a post 400 is disclosed which comprises tube 450, an elongated rod 442, and a flange 444, which is removably coupled to a base assembly 446. The elongated rod 442 may at least be partially surrounded by an inner wall 450. In one embodiment, the rod 442 comprises a carbon-carbon rod and the support post 400 comprises a ceramic material due to its endurance to molten aluminum. In this embodiment, the inner wall 450 comprises silicon carbon. In this embodiment, the removably coupled base assembly 446 comprises graphite and is configured to receive, engage, retain, and/or otherwise mate to the cap 476. The elongated rod 442, by comprising a carbon-carbon material, can be pre-loaded with pressure that will not unload at an increased temperature. In other words, the use of CTE negates the need for the prior art use of a spring, which is subject to mechanical failure over time. Also shown is a grafoil gaskets 460, a graphite block 461, a stainless steel split ring 463, a stainless steel stopper 464 a stainless steel bolt 465, an electrical leak detector 466, a ceramic electrical isolator 470, and ceramic wool packing 473, as are routinely used in the field in conventional manners known to those of skill in the art.

Thus, it is apparent that there has been provided in accordance with the present invention, a molten metal pump that fully satisfies the objects, aims, and advantages as set forth above. While the invention has been described in conjunction with specific embodiments thereof, it is evident that many alternatives, modifications and variations will be apparent to those skilled in the art like of the foregoing description. Accordingly, it is intended to embrace all such alternatives, modifications and variations as fall within the spirit and broad scope of the appended claims.

1. A molten metal pump post comprising:
an elongated rod of a first material that is heat resistant;
an inner member at least partially surrounding the elongated rod wherein the inner member is of a second material; and
wherein the elongated rod is operable due to a difference in a coefficient of thermal expansion between the elongated rod and the inner member which creates a compressive force.

2. The molten metal pump post of claim 1 wherein the first material of the elongated rod provides no compressive force at room temperature and provides compressive force at a temperature above 500° C.

3. The molten metal pump post of claim 1 wherein the first material of the elongated rod comprises steel or a steel alloy.

4. The molten metal pump post of claim 1 wherein the second material of the inner member comprises tungsten and/or titanium.

5. The molten metal pump post of claim 4 wherein the elongated rod is preloaded with tension at room temperature and does not unload at a temperature about 500° C.

6. The molten metal pump post of claim 1 where in the difference in coefficient of thermal expansion is at least 0.001852 ppm/° C.

7. The molten metal pump post of claim 1 wherein the difference in coefficient of thermal expansion is at least 0.011109 ppm/° C.

8. The molten metal pump post of claim 1 wherein the elongated rod comprises carbon-carbon.

9. The molten metal pump post of claim 8 wherein the elongated rod is preloaded with tension at room temperature and does not unload at a temperature about 500° C.

10. The molten metal pump post of claim 8 further comprising a stainless steel flange coupled to the elongated rod.

11. The molten metal pump of claim 1 further comprising an outer sheath.

12. The molten metal pump of claim 11 wherein the inner member is disposed between the rod and the outer sheath.

13. An assembly for attaching an associated molten metal pump post to a component of a molten metal pump, the assembly comprising a rod having a first end that accommodates an elongated refractory element and an opposed end at least partially surrounded by an inner member wherein the assembly uses thermal expansion to create a compressive force.

14. The assembly of claim 13 wherein the rod comprises steel or a steel alloy.

15. (canceled)

16. (canceled)

17. (canceled)

18. The assembly of claim 13 further comprising an outer sheath.

19. The assembly of claim 18 wherein the inner member is disposed between the rod and the outer sheath.

20. The assembly of claim 13 wherein the inner member comprises carbon-carbon and a packing material, such as a ceramic fiber, provided to reduce exposure of the inner member to an external atmosphere.

21. A molten metal pump comprising:
an elongated rod of a first material that is heat resistant;
an inner member at least partially surrounding the elongated rod wherein the inner member is of a second material; and
wherein the elongated rod is operable due to a difference in a coefficient of thermal expansion between the elongated rod and the inner member which creates a compressive force.

22. The molten metal pump of claim 21 further comprising a cap and a base.

23. The molten metal pump post of claim 22 wherein the cap is removably coupled to the base.
